(19) United States
(12) Patent Application Publication
(10) Pub. No.: US 2026/0253200 A1
(43) Pub. Date: Aug. 27, 2026

(54) SPATIAL INFORMATION BASED ANOMALY DETECTION

(71) Applicant: AI QUALISENSE 2021 LTD, Tel Aviv-Yafo (IL)

(72) Inventors: Tom TABAK, Tel Aviv (IL); Karina Odinaev, Tel Aviv (IL); Shimon Cohen, Ness Ziona (IL)

(73) Assignee: AI QUALISENSE 2021 LTD, Tel Aviv-Yafo (IL)

(21) Appl. No.: 18/877,980

(22) PCT Filed: Jun. 20, 2023
(86) PCT No.: PCT/US2023/025790

§ 371 Date: Dec. 20, 2024

Related U.S. Application Data
(60) Provisional application No. 63/366,693, filed on Jun. 20, 2022.
(60) Provisional application No. 63/371,061, filed on Aug. 10, 2022.
(60) Provisional application No. 63/371,065, filed on Aug. 10, 2022.
(60) Provisional application No. 63/373,070, filed on Aug. 21, 2022.
(60) Provisional application No. 63/373,455, filed on Aug. 25, 2022.
(60) Provisional application No. 63/373,859, filed on Aug. 29, 2022.
(60) Provisional application No. 63/379,137, filed on Oct. 11, 2022.

(51) Int. Cl. G06T 7/00; G06T 3/18; G06T 7/13; G06V 10/25; G06V 10/764; G06V 10/774; G06V 10/776; G06V 10/82

(52) U.S. Cl. CPC G06T 7/001; G06T 3/18; G06T 7/13; G06V 10/25; G06V 10/764; G06V 10/774; G06V 10/776; G06V 10/82; G06T 2207/20076; G06T 2207/20081; G06T 2207/20084; G06T 2207/30108; G06V 2201/06

(57) ABSTRACT

A method for region of interest (ROI) defect detection related to an evaluated manufactured item (MI), the method includes obtaining a reference MI image; obtaining a reference ROI definition; obtaining the evaluated MI image; feeding the reference MI image and the evaluated MI image to a neural network; detecting, by the neural network, one or more geometrical warping operations that once applied on the reference MI image results in an approximation of the evaluated MI image; applying the one or more geometrical warping operations on the reference ROI definition to provide a definition of an evaluated MI image ROI; and applying an ROI-based defect detection process on the evaluated MI image, based on the evaluated MI image ROI.

### CROSS REFERENCE

This patent application claims priority from each one of:
U.S. provisional patent Ser. No. 63/366,693 filing date Jun. 20, 2022.
U.S. provisional patent Ser. No. 63/371,061 filing date Oct. 8, 2022.
U.S. provisional patent Ser. No. 63/371,065 filing date Oct. 8, 2022.
U.S. provisional patent Ser. No. 63/373,070 filing date Aug. 21, 2022.
U.S. provisional patent Ser. No. 63/373,455 filing date Aug. 25, 2022.
U.S. provisional patent Ser. No. 63/373,859 filing date Aug. 29, 2022.
U.S. provisional patent Ser. No. 63/379,137 filing date Nov. 10, 2022.

All US provisional patents being incorporated herein in their entirety.

### BACKGROUND

Defect detection may include processing an image of an evaluated manufactured item (MI). The evaluated MI may cover only a part of the image. The other part of the image may include other pixels that are irrelevant to the defect detection process.

The other pixels may introduce errors in the defect detection process.

There is a growing need to provide an accurate defect detection process.

The retina net is a neural network used for defect detection. The neural network include multiple predictors (each including a bounding box subnet and a class subnet) for different spatial resolutions.

The bounding box subnets are much larger and time consuming (for example—by a factor of four) than the class subnet. They perform bounding box regression that may involve calculating thousands of bounding box candidates. The loss function of the neural network is also dependent on the outputs of the bounding box subnets-which also lengthens the training process.

Using bounding box subnets requires extensive computational and memory resources.

There is a growing need to provide an efficient defect detection network.

The evaluation of manufactured items is highly complex-especially when there is a need to assess inter-defect variation and intra-defect variability.

There is a need to provide an unsupervised extensible way to detect defects.

Neural network include multiple layers. The multiple layers output descriptor maps that include descriptors that include descriptor segments that includes content from multiple channels.

Storing and processing multi-channel descriptors may require significant memory and computational resources.

There is a growing need to provide a more efficient representation of descriptors.

### BRIEF DESCRIPTION OF THE DRAWINGS

The embodiments of the disclosure will be understood and appreciated more fully from the following detailed description, taken in conjunction with the drawings in which:

FIG. 1 illustrates an example of an image of a manufactured item;

FIG. 2 illustrates an example of an image and of a feature pyramid network (FPN);

FIG. 3 illustrates an example of an image, an FPN and a ROI mask;

FIG. 5 illustrates an example of a method;

FIG. 6 illustrates an example of a training process and an inference process; and

FIG. 7 illustrates an example of a system.

FIG. 8 illustrates an example of FPN;

FIG. 9 illustrates an example of an image and of a bounding-box-less feature pyramid network (FPN);

FIG. 10 illustrates an example of a method;

FIG. 11 illustrates an example of a method;

FIG. 12 illustrates an example of a method;

FIG. 13 illustrates an example of data structures;

FIG. 14 illustrates an example of a method;

FIG. 15 illustrates an example of a method;

FIG. 16 illustrates an example of a method;

FIG. 17 illustrates an example of a method;

FIG. 18 illustrates an example of a method;

FIG. 19 illustrates an example of a data structures;

FIG. 20 illustrates an example of a method; and

FIG. 21 illustrates an example of data elements.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components an63/379,137d circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of the perception unit, narrow AI agents, MI evaluation unit may be implemented in hardware and/or code, instructions and/or commands stored in a non-transitory computer readable medium, may be included in a vehicle, outside a vehicle, in a mobile device, in a server, and the like.

The specification and/or drawings may refer to an image. An image is an example of a media unit. Any reference to an image may be applied mutatis mutandis to a media unit. A media unit may be an example of sensed information. Any reference to a media unit may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors-such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

There is provided a method for compensating for warps and determining ROI in evaluated IM images.

There may be provided a method for region of interest (ROI) defect detection, the method emphasizes the content of pixels within a ROI while ignore of reduce the impact of pixels outside the ROI. The method improves the reliability, repeatability and accuracy of the defect detection process.

The method may process a large number of images each image may include

thousands (and even more) pixels, to provide real time indication about the state of evaluated MIs. Real time many mean tens of images per second and even more. This real time processing may be crucial in MIs evaluation- and allows to send real time feedback to a manufacturing process, and for other purposes.

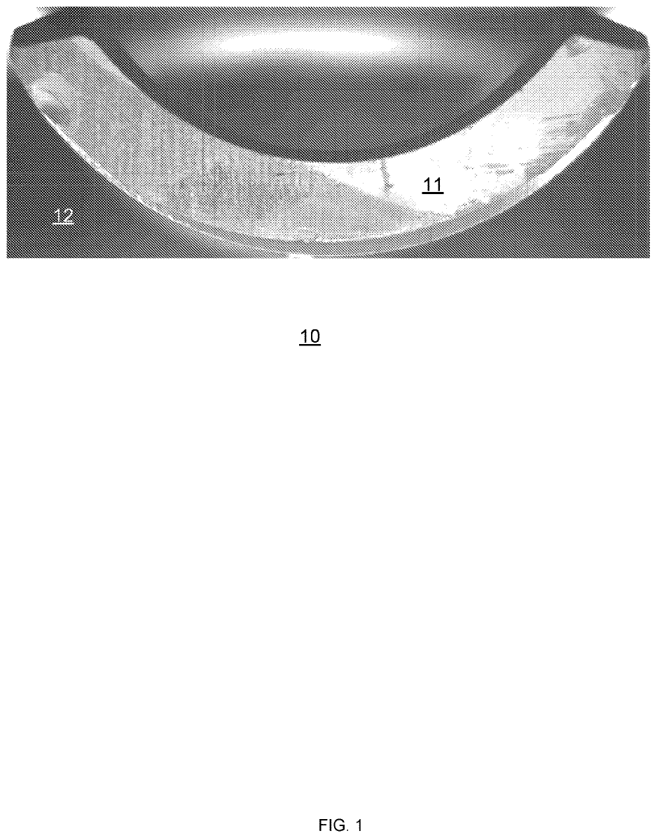

FIG. 1 illustrates an example of an image 10 of a manufactured item—the image 10 include a ROI 11 that corresponds to the manufacture item, and other parts 12 of the image 10 located outside the ROI.

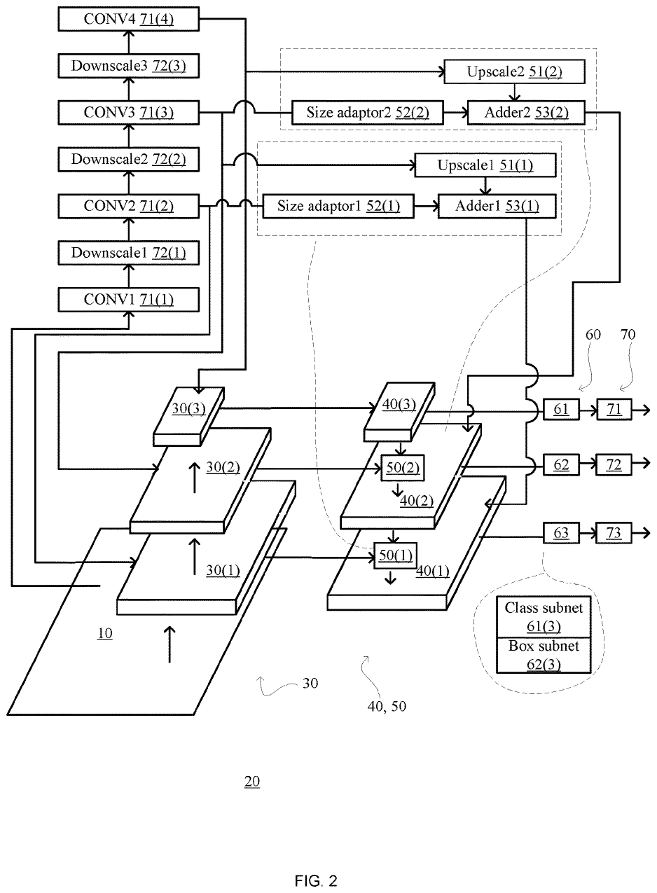

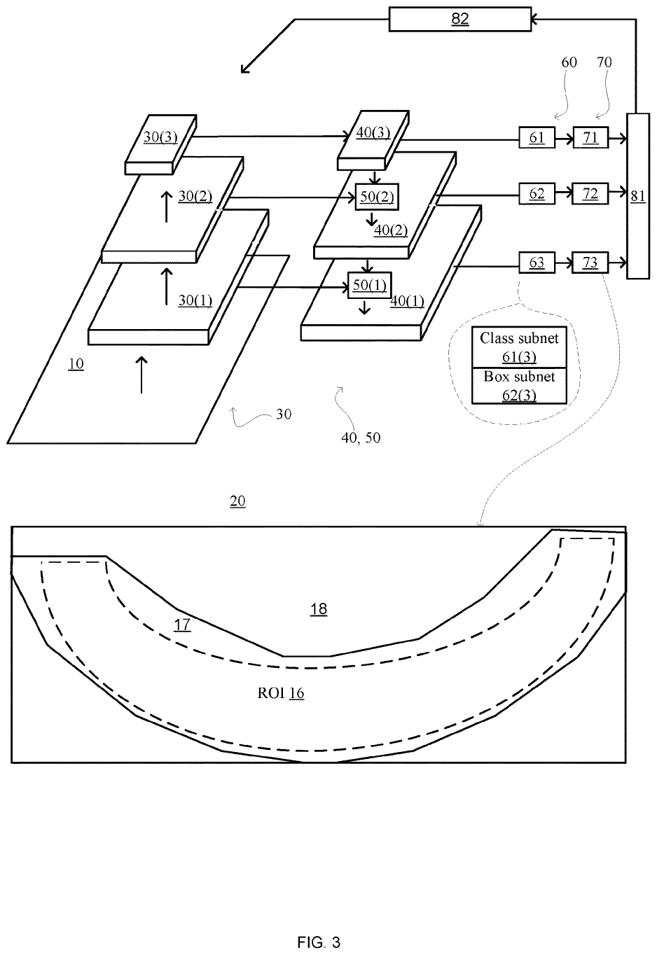

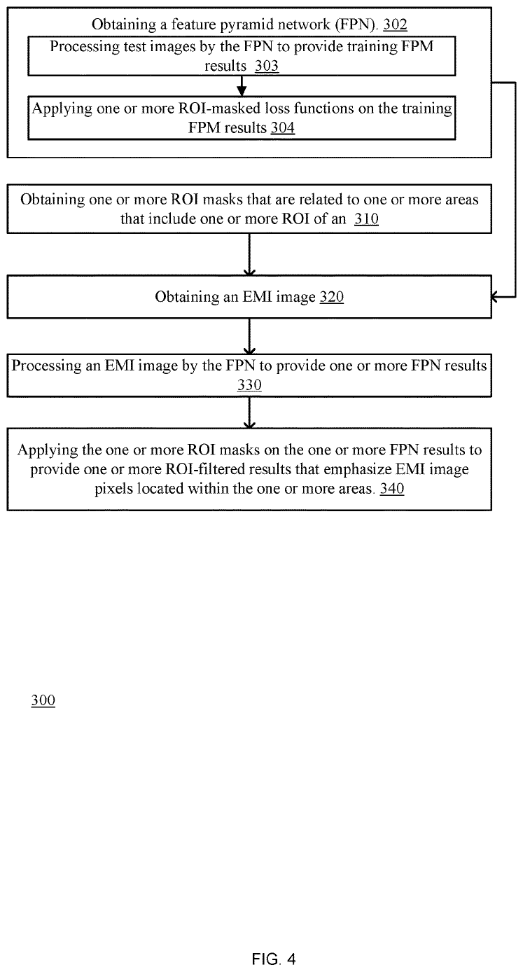

FIGS. 2 and 3 illustrate examples of an image 10 and an FPN 20.

FIG. 2 illustrate more details regarding the FPN, while FIG. 3 illustrates one or more loss functions and an FPN adjustment unit 82 that are used during the training of the FPN.

The FPN 20 includes a backbone network 30, a feature pyramid 40, predictors 61-63 and ROI masks 71-73.

For simplicity of explanation-FIGS. 2 and 3 illustrate an FPN that has its backbone network 30 output (to the feature pyramid 40) three feature maps related to the EMI image (first feature map 30(1), second feature map 30(2) and third feature map 30(3)) of three different spatial resolutions (and of three contextual strengths). It should be noted that the FPN may output two feature maps or more than three feature maps.

The backbone network 30 may include a sequence that include first convolution layer (CONV1 71(1)), first downscaling unit (downscale1 72(1)), second convolution layer (CONV2 71(2)), second downscaling unit (downscale2 72(2)), third convolution layer (CONV3 71(3)), third downscaling unit (downscale3 72(3)), and fourth convolution layer (CONV4 71(4)).

The downscaling may by a factor of two—but other downscaling factors may be provided.

The fourth convolution layer outputs the third feature map 30(3) (that may equal a third feature map (40(3)) of the feature pyramid). The third convolution layer outputs the second feature map 30(2). The second convolution layer outputs the first feature map 30(1).

The feature pyramid include a first merging and size adaptation unit 50(1) and a second merging and size adaptation unit 50(2). The feature pyramid (FP) obtains first FP feature map 40(3) and calculates second FP feature map 40(2) and first FP feature map 40(1).

Each merging and size adaptation unit performs size adaptation (for example upsampling and channel length alignment) and add a size adjusted FP feature map to a lower level size adjusted feature map of the backbone network.

The second merging and size adaptation unit 50(2) includes a second upscaling unit (Upscale2 51(2)) that outputs an upscaled version of third FP feature map 40(3), a second size adaptor (Size adaptor2 52(2)—for example a 1×1 correlation unit) that outputs a channel size adapted second feature vector 30(2), and a second adder (Adder2 53(2)) that adds the outputs of the second size adaptor and the second upscaling unit to provide a second merging and size adaptation output that is the second FP feature map 40(2) of the feature pyramid.

The first merging and size adaptation unit 50(1) includes a first upscaling unit (Upscale1 51(1)) that outputs an upscaled version of second FP feature map 40(2), a first size adaptor (Size adaptor1 52(1)—for example a 1×1 correlation unit) that outputs a channel size adapted first feature vector 30(1), and a first adder (Adder1 53(1)) that adds the outputs of the first size adaptor and the first upscaling unit to provide a first merging and size adaptation output that is the first FP feature map 40(1).

The first FP feature map 40(1) is fed to first predictor 61 (for example an FP class subnet and an FP location subnet) that output a first FPN result—that is filtered by first ROI mask 71 to provide a first ROI-filtered result that emphasize EMI image pixels located within a first area that includes a first ROI of the EMI image—and is associated with the first spatial resolution.

The second FP feature map 40(2) is fed to second predictor 62 (for example an FP class subnet and an FP location subnet) that output a second FPN result—that is filtered by second ROI mask 72 to provide a second ROI-filtered result that emphasize EMI image pixels located within a second area that includes a second ROI of the EMI image—and is associated with the second spatial resolution.

The third FP feature map 40(3) is fed to third predictor 63 (for example an FP class subnet 61(3) and an FP location subnet 62(3)) that output a third FPN result—that is filtered by third ROI mask 73 to provide a third ROI-filtered result that emphasize EMI image pixels located within a third area that includes a third ROI of the EMI image—and is associated with the third spatial resolution.

The first, second and third FPN results may be probability maps having pixels that are associated with a pixel probability of defect-a probability that a pixel is a pixel of a defect.

FIG. 3 illustrates an example of training of the FPN 20—and especially illustrates that during the training, one or more loss functions 81 is calculated based on first, second and third ROI-filtered results outputted from first, second and third ROI masks 71, 72 and 73.

FIG. 3 also illustrates that the output of the one or more loss functions 81 are fed to a FPN adjustment unit 82 that is configured to change the configuration of the FPN according to the output from the one or more loss functions 81. FIG. 3 also illustrates the third ROI mask 71 that includes mask ROI pixels 16 (delimited by dashed lines), mask margins pixels 17, and mask outside pixels 18 associated with one or more segments outside the area formed by ROI and the one or more margins. The mask pixels may be binary (for example set ROI pixels, set one or more margin pixels and reset outside pixels)—or may have weights.

The first and second ROI masks may differ from each other and/or from the third ROI mask—as they are generated based on different feature maps.

FIG. 4 illustrates an example of a method 300 for region of interest (ROI) defect detection.

Method 300 may start by step 310 of obtaining one or more ROI masks that are related to one or more areas that include one or more ROI of an evaluated manufactured item (EMI). It should be noted that if method 400 is applied the areas may equal the ROIs and there may be no need to define (within the areas) margins.

Step 310 may include receiving the one or more ROI masks, generating the one or more ROI masks, or a combination thereof.

Accordingly—an ROI mask may include an area that should be evaluated and one or more other segments of the image that should be ignored of. The area may include an ROI and one or more margins. It should be noted that if method 400 is applied the areas may equal the ROIs and there may be no need to define (within the areas) one or more margins.

An ROI mask may include multiple ROIs and multiple corresponding areas. For simplicity of explanation we assume that there is a single ROI and a single area per ROI mask.

The ROI may be defined and/or or learnt in any manner—for example may be defined by a user, by a manufacturer of the EMI, or based on one or more manufactured items (MIs) that are regarded to be flawless or be of at least a certain number and/or type of defects. The certain number and/or type of defects may be defined in any manner—for example may be defined by a user, by a manufacturer of the MIs, and the like. The MIs may be EMIs or may differ from MIs—for example be reference MIs.

The one or more margins may be provided in order to obtain information regarding the ROI even at the presence of misregistration and/or other phenomena that may wrap or changes to an acquired image.

Any dilution function may be applied on ROI to provide the one or more margins.

It is assumed that the one or more ROI masks are multiple ROI masks that are associated with different feature maps, the different feature maps are associated with different spatial resolutions and are generated during step 330.

Steps 302 and 310 may be followed by step 320 of obtaining an EMI image. The obtaining may include receiving the EMI image or generating the EMI image.

Step 320 may be followed by step 330 of processing an EMI image by a feature pyramid network (FPN) to provide one or more FPN results. The FPN was trained using one or more ROI-masked loss functions.

An ROI-masked loss function is a loss function that is applied on ROI-masked FPN results. The ROI-masked FPN results are results that may be outputted by subnets of the FPN, after the results were ROI-filtered in order to ignore FPM results related to segments outside the ROI.

It is assumed that the one or more FPN results are multiple FPM results, and that the processing of step 330 may include generating the different feature maps.

The FPM results are outputted from subnets associated with the different spatial resolutions. The subnets may include a box subnet and a class subnet per spatial resolution of the different spatial resolutions.

The FPM results may be FPM feature maps.

Step 330 may be followed by step 340 of applying the one or more ROI masks on the one or more FPN results to provide one or more ROI-filtered results that emphasize EMI image pixels located within the one or more areas.

For example—assuming that there are multiple ROI masks then an ROI mask associated with a certain spatial resolution is applied on a FPN result associated with the certain spatial resolution.

The emphasizing may include ignoring FPN metadata related to pixels outside the area—for example ignoring FPM feature map elements that are located outside the areas defined by the multiple ROI masks.

Alternatively—the emphasizing may include assigning a lower nonzero weight to such elements. Lower in relation to the elements within the ROI. Lower—for example by a factor of at least 3, 6, 9 and more.

Method 300 may include step 302 of obtaining the FPN.

Step 302 may include receiving the FPN after the FPN was trained using the one or more ROI-masked loss functions. Alternatively—step 302 may include training the FPN using the one or more RO-masked loss functions.

Step 302 may include step 303 of processing test images by the FPN to provide training FPM results, and step 304 of applying one or more ROI-masked loss functions on the training FPM results.

The one of the one or more ROI-masked loss functions may include a ROI-masked classification loss function and a ROI-masked position loss function.

The one or more ROI-masked classification loss functions may be one or more ROI-masked focus functions.

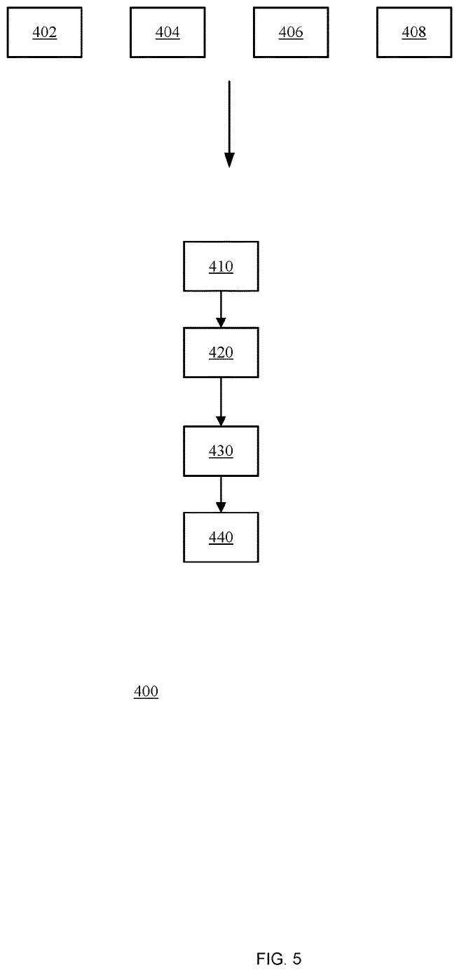

FIG. 5 illustrates method 400 for ROI defect detection related to an evaluated manufactured item (MI).

Method 400 may start by steps 402, 404 and 406.

Obtaining may mean receiving or generating.

Step 402 may include obtaining a reference MI image. The reference MI image may be an acceptable MI. An acceptable MI may be defect free. An acceptable MI may be an MI that may not be completely defect free—but may be acceptable according to a certain definition. The certain definition may be determined in any manner—for example may be determined by a manufacturer of the MI, by a consumer of the MI, by a client of the manufacturer, based on previous tests of the MI, and the like.

An acceptable MI may exhibit at least one of the following—be of an acceptable functionality and/or include an acceptable overall number of defects and/or include an acceptable distribution of defects, include an acceptable type of defects, and the like.

Step 404 may include obtaining a reference ROI definition—which is the ROI within the reference MI image.

Step 406 may include obtaining the evaluated MI image.

Steps 402, 404 and 406 may be followed by step 410 of feeding the reference MI image and the evaluated MI image to a neural network.

Step 410 may be followed by step 420 of detecting, by the neural network, one or more geometrical warping operations that once applied on the reference MI image results in an approximation of the evaluated MI image.

Step 420 may be followed by step 430 of applying the one or more geometrical warping operations on the reference ROI definition to provide a definition of an evaluated MI image ROI.

Step 420 may be followed by step 440 of applying an ROI-based defect detection process on the evaluated MI image, based on the evaluated MI image ROI. An example of an ROI-based defect detection process is illustrated in FIG. 4. Any other ROI-based defect detection process may be applied. An ROI-based defect detection process is a defect detection process that emphasizes information located within an ROI—and reduces the relevancy (even ignores) the information located outside the ROI.

The one or more geometrical warping operations may include rotation, shift, shearing and projection.

The one or more geometrical warping operations are represented by a multi-dimensional warping matrix—such as a three by three warping matrix.

The neural network may be trained by feeding the neural network with test images and randomly wrapped versions of the test images. The test images are randomly warped (for example by randomly assigning values to the elements of the warping matrix) to provide the randomly wrapped versions of the test images.

Method 400 may include step 408 of training the neural network by feeding the neural network with test images and randomly wrapped versions of the test images.

Step 408 may include feeding the neural network with test images and randomly wrapped versions of the test images, wherein at some test images include tagged defects. Step 408 may include obtaining information about an appearance of defects in the randomly wrapped versions of the test images.

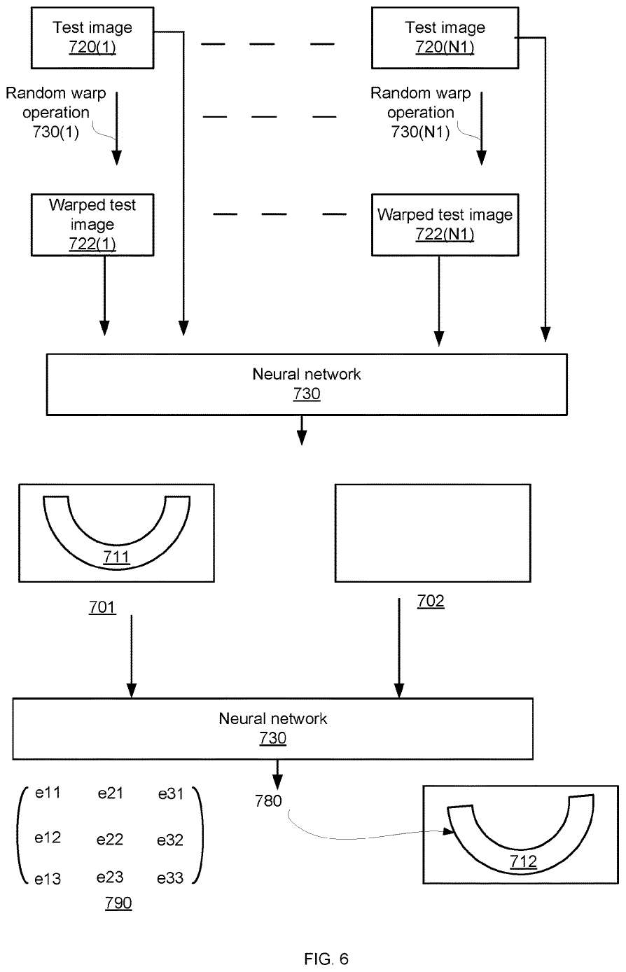

FIG. 6 illustrates a training process and an inference process.

The training includes feeding test images 720(1)-720(N1) and wrapped test images 722(1)-722(N1) (obtained by randomly transforming-applying random wrap operations 730(1)-730(N1)) to the neural network 730.

The inference include feeding reference MI image 701 (with ROI) and the evaluated MI image 702 to the neural network 730 that determines the warp 780—to determine the ROI 712 in the evaluated MI image 702. This figure also illustrates a three by three warping matrix 790.

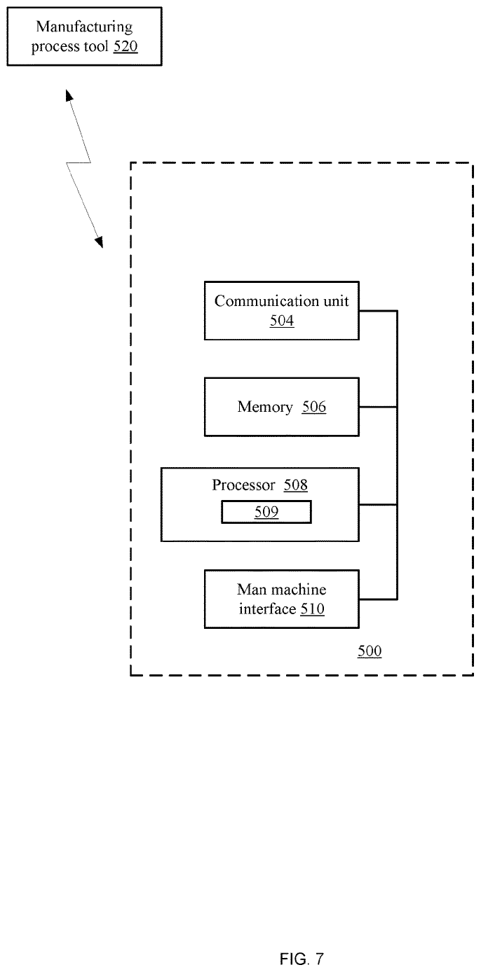

FIG. 7 is an example of a computerized system 500 and a manufacturing process tool 520.

The computerized system 500 may execute method 100.

The computerized system 500 may or may not communicate with the manufacturing process tool 520. It may, for example, provide feedback (for example the process variation alert) about the manufacturing process applied by the manufacturing process tool 520 (that manufactured the evaluated manufactured items) and/or for receiving images of the evaluated manufactured items, and the like. The computerized system 500 may be included in the manufacturing process tool 520.

The computerized system 500 may include communication unit 504, memory 506, processor 508 and may optionally include a man machine interface 510.

Processor 508 may execute the steps of method 300 and/or method 400. Memory 506 is configured to store any data element illustrated in any of the previous figures.

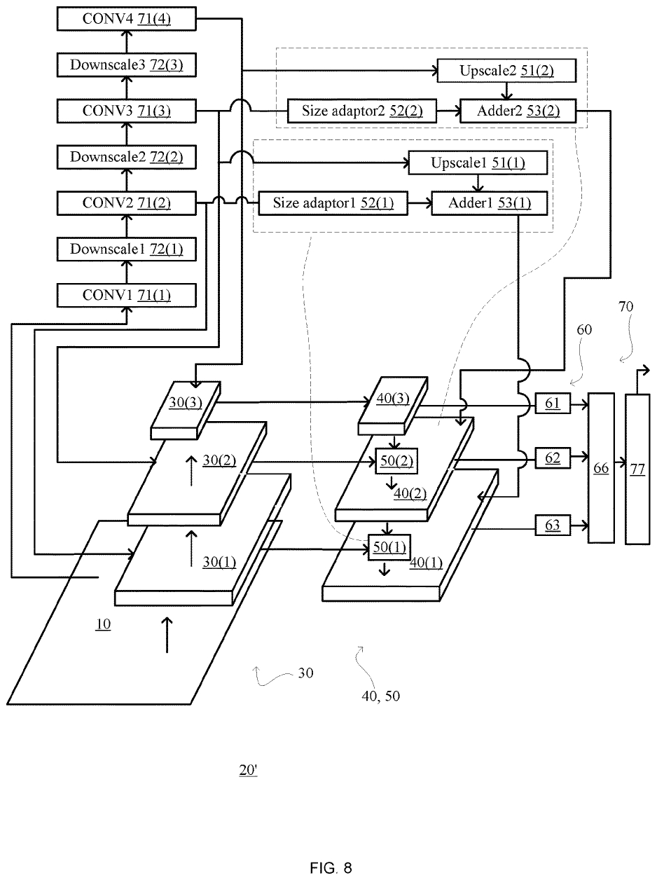

FIG. 8 illustrates an example of FPN 20′.

FPN 20′ of FIG. 8 differs from FPN 20 of FIG. 2 by applying a single ROI mask 77 on a sum (generated by size compensation and added unit 66) of size compensated (to be of the same size) first, second and third FPN results-outputted from the first second and third predictors 61, 62 and 63. This process requires less resources and is faster than the process implemented by the FPN 20 of FIG. 2.

It should be noted that PFN 20′ may be trained using the scheme illustrated in FIG. 3—without summing the size compensated first, second and third FPN results—and with separate ROI masks for separate spatial resolutions.

### Low Footprint Neural Network for Defect Detection and Localization

There may be provided a method for efficient defect detection in which the bounding box prediction of the neural network (for example—a retina net) is replaced by a set of operations that require much less resources and a much faster. The set of operations may include generating a merged probability map, binarizing the merged probability map, generating binding boxes based on edges of the binarized merged probability map, and determining binding boxes probabilities.

The method may process a large number of images each image may include thousands (and even more) pixels, to provide real time indication about the state of evaluated MIs. Real time many mean tens of images per second and even more. This real time processing may be crucial in MIs evaluation—and allows to send real time feedback to a manufacturing process, and for other purposes.

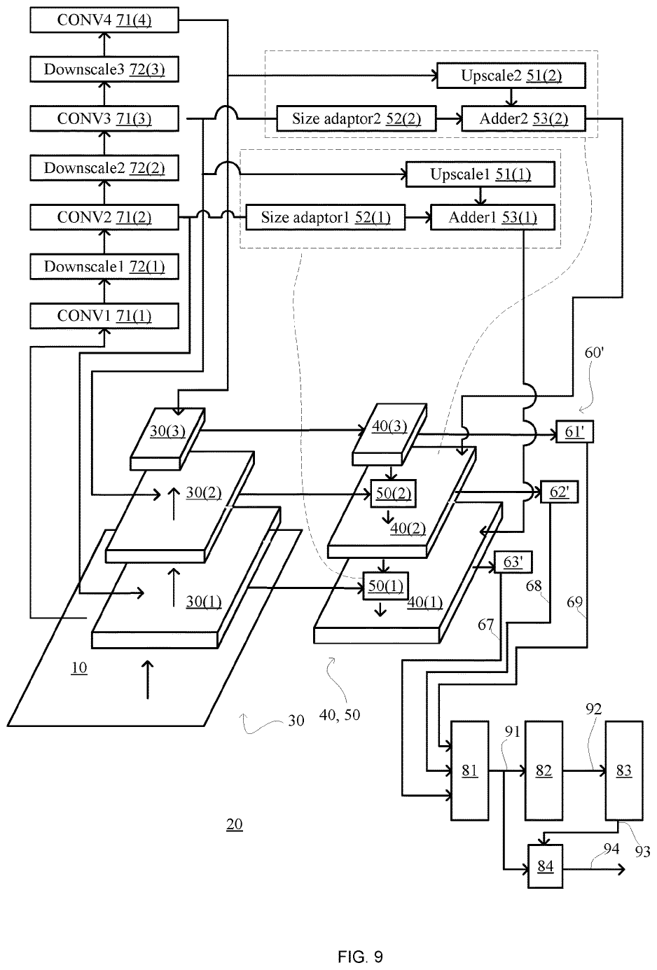

FIG. 9 illustrates an example of an image 10 and an FPN 20.

The FPN 20 includes a backbone network 30, a feature pyramid 40, bounding-box-less predictors 61′-63′, merged probability map generator 81, binarization unit 82, bounding box generator 83, and bounding boxes probability calculator 84.

For simplicity of explanation—FIG. 1 illustrates a backbone network 30 that outputs (to the feature pyramid 40) three feature maps related to the EMI image (first feature map 30(1), second feature map 30(2) and third feature map 30(3)) of three different spatial resolutions (and of three contextual strengths). It should be noted that the FPN may output two feature maps or more than three feature maps.

The backbone network 30 may include a sequence that include first convolution layer (CONV1 71(1)), first downscaling unit (downscale1 72(1)), second convolution layer (CONV2 71(2)), second downscaling unit (downscale2 72(2)), third convolution layer (CONV3 71(3)), third downscaling unit (downscale3 72(3)), and fourth convolution layer (CONV4 71(4)).

The downscaling may by a factor of two—but other downscaling factors may be provided.

The fourth convolution layer outputs the third feature map 30(3) (that may equal a third feature map (40(3)) of the feature pyramid). The third convolution layer outputs the second feature map 30(2). The second convolution layer outputs the first feature map 30(1).

The feature pyramid include a first merging and size adaptation unit 50(1) and a second merging and size adaptation unit 50(2). The feature pyramid (FP) obtains first FP feature map 40(3) and calculates second FP feature map 40(2) and first FP feature map 40(1).

Each merging and size adaptation unit performs size adaptation (for example upsampling and channel length alignment) and add a size adjusted FP feature map to a lower level size adjusted feature map of the backbone network.

The second merging and size adaptation unit 50(2) includes a second upscaling unit (Upscale2 51(2)) that outputs an upscaled version of third FP feature map 40(3), a second size adaptor (Size adaptor2 52(2)—for example a 1×1 correlation unit) that outputs a channel size adapted second feature vector 30(2), and a second adder (Adder2 53(2)) that adds the outputs of the second size adaptor and the second upscaling unit to provide a second merging and size adaptation output that is the second FP feature map 40(2) of the feature pyramid.

The first merging and size adaptation unit 50(1) includes a first upscaling unit (Upscale1 51(1)) that outputs an upscaled version of second FP feature map 40(2), a first size adaptor (Size adaptor1 52(1)—for example a 1×1 correlation unit) that outputs a channel size adapted first feature vector 30(1), and a first adder (Adder1 53(1)) that adds the outputs of the first size adaptor and the first upscaling unit to provide a first merging and size adaptation output that is the first FP feature map 40(1).

The first FP feature map 40(1) is fed to a first bounding-box-less predictor 61′ (that may have an FP class subnet but is without and bounding-box subnet) that outputs a first FPN result—that is a first probability map 67.

The second FP feature map 40(2) is fed to a second bounding-box-less predictor 62′ that outputs a second FPN result—that is a second probability map 68.

The third FP feature map 40(3) is fed to a third bounding-box-less predictor 63′ that outputs a third FPN result—that is a third probability map 69.

The first, second and third probability maps 67, 68 and 69 are fed to a merged probability map generator 81. The first, second, and third probability maps 67, 68 and 69 are associated with different spatial resolutions and thus are converted to have the same size (same number of pixels) by interpolation of any other size compensation operation. Three size-compensated probability maps are merged—for example by averaging, adding or weighted summing—to provide the merged probability map 91.

The binarization unit 82 thresholds the merged probability map 91 to provide a binarized probability map 92. The threshold may be set according to a desired defect detection probability—for example may be one or more of a false positive rate, a false negative rate, a true positive rate and/or a true negative rate. The pixels of the binarized probability map are either one or zero.

The binarized probability map 92 is sent to the bounding box generator 83 that finds, based on the binarized probability map, bounding boxes and generated bounding boxes information 93.

The bounding boxes information 93 and the merged probability map 91 are sent to the bounding boxes probability calculator 84 that calculates the defect probability associated with each bounding box.

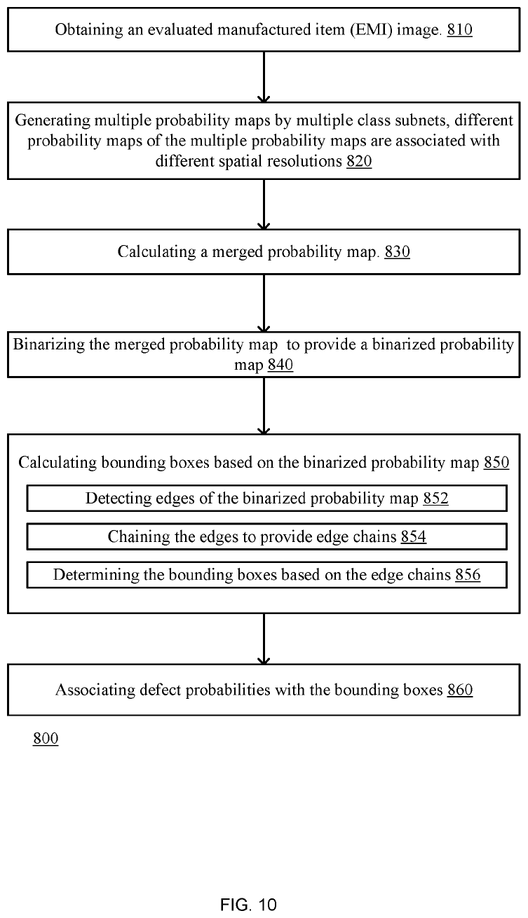

FIG. 10 illustrates an example of a method 800 for defect detection.

Method 800 may start by step 810 of obtaining an evaluated manufactured item (EMI) image.

Step 810 may include receiving the EMI image or generating the EMI image.

Step 810 may be followed by step 820 of generating multiple probability maps by multiple class subnets, different probability maps of the multiple probability maps are associated with different spatial resolutions.

Step 820 may include:
a. Generating, by a backbone network, multiple feature maps of the different spatial resolutions and of different contextual strengths.
b. Generating, by a feature pyramid (FP) net, FP feature maps, based on the multiple feature maps generated by the backbone network.
c. Generating the multiple probability maps by class subnets of bounding-box-less predictors.

Step 820 may be executed by a bounding-box-subnet-less feature pyramid network (FPN).

Step 820 may be followed by step 830 of calculating a merged probability map.

The multiple probability maps are associated with different spatial resolutions and thus are converted to have the same size (same number of pixels) by interpolation of any other size compensation operation. Three size-compensated probability maps are merged—for example by averaging, adding or weighted summing—to provide the merged probability map.

Step 830 may be followed by step 840 of binarizing the merged probability map to provide a binarized probability map.

The binarizing may include thresholding the merged probability map to provide a binarized probability map. The threshold may be set according to a desired defect detection probability—for example may be one or more of a false positive rate, a false negative rate, a true positive rate and/or a true negative rate. The pixels of the binarized probability map are either one or zero.

Step 840 may be followed by step 850 of calculating bounding boxes based on the binarized probability map.

Step 850 may include step 852 of detecting edges of the binarized probability map, step 854 of chaining the edges to provide edge chains and step 856 of determining the bounding boxes based on the edge chains. Edge is detected when a reaching a change between a set value and a reset value- and vice-verse. Each edge is a part of the polygon.

Step 850 may be followed by step 860 of associating defect probabilities with the bounding boxes, wherein the defect probabilities are calculated based on the merged probability map.

Step 860 may include averaging merged probability map pixels bounded by the bounding box.

Step 860 may include finding a highest value probability map pixel output probability map pixels bounded by the bounding box.

Method 800 may be executed without performing box subnet calculations.

Spatial predictors for anomaly detection

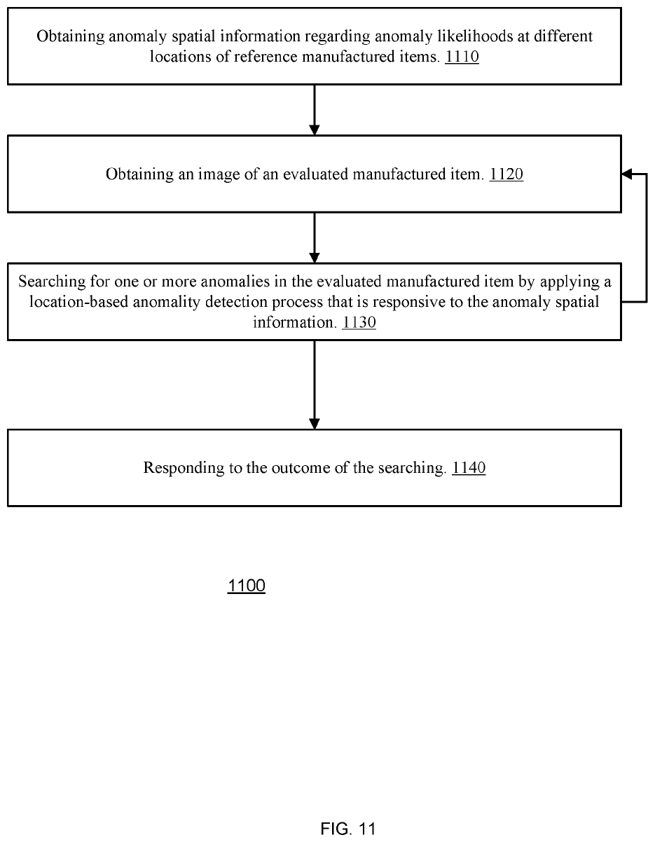

FIG. 11 illustrates an example of method 1100 for anomaly detection.

Method 1100 may be used to evaluated so-called evaluated manufactured items.

Method 1100 may start by step 1110 of obtaining anomaly spatial information regarding anomaly likelihoods at different locations of reference manufactured items.

Step 1110 may include receiving the anomaly spatial information and/or generating the anomaly spatial information.

The anomality spatial information may map different locations of a manufacture items to a likelihood that the different locations will exhibit anomalies. A location may be associated with a pixel of an image of the manufactured item, with a patch of multiple pixels, and the like. At least two patches may be of the same shape and size. At least two patches may differ from each other by shape and/or size. Some example may refer to rectangular shaped multi-pixel patches of the same size—but this is just an example.

The anomaly spatial information may be generated by processing images of reference manufactured items. The processing may be executed using a machine learning process, without using a machine learning process, by a combination of a machine learning process and non-machine learning process processing, in a supervised manner, in a non-supervised manner, by a combination of a supervised manner and non-supervised manner.

It should be noted that the count may be of abnormalities of any type per location.

It should be noted that there may be different classes of abnormalities and the anomaly spatial information may be indicative of a probabilities of occurrence per class of abnormality—of per group of classes of abnormality.

The reference items may share (or may be assumed to share) a same or similar abnormality statistics. It should be noted that method 1100 may provide an indication that there is a discrepancy between the abnormality statistics represented in the anomaly spatial information and the abnormality statistics of the evaluated items. In such a case the abnormality statistics may be updated, an alert may be sent to the user or any other entity, a process variation change may be detected or reevaluated, and the like.

The reference manufactured items and the evaluated manufactured items may be instances of the same manufactured item.

Step 1110 may include calculating or receiving at least one out of (a) probabilities of occurrences of anomalies at different locations of reference manufactured items, (b) sensitivity threshold matrix, or (c) sensitivity matrix.

The probabilities and/or the sensitivity matrix and/or the sensitivity threshold matrix may be per any class of abnormality or per class of abnormality or per group of classes of abnormality. Different classes may include, for example a vertical scratch, a horizontal scratch, missing material, excess material, foreign particles, and the like. A group of classes may include scratches of different orientations. Additionally or alternatively, the classes may refer to the impact of the abnormalities—for example critical defects, non-critical defect, and the like.

Step 1110 may be followed by multiple sequences of steps-starting from step 1120 of obtaining an image of an evaluated manufactured item.

Obtaining may include receiving or generating the image. Step 1120 may include using one or more sensors (passive or active and/or stand alone or being a part of an evaluation system) to obtain the image.

Step 1120 may be followed by step 1130 of searching for one or more anomalies in the evaluated MI by applying a location-based anomality detection process that is responsive to the anomaly spatial information.

Step 1130 may be followed by step 1140 of responding to the outcome of the searching. The outcome may include not finding any abnormalities, finding the one or more anomalies, updating the anomaly spatial information, generating an alert (when finding a deviation) to the user or any other entity, indicating that a process variation change may have occurred, generating and/or sensing and/or storing information regarding the outcome of step 1130, requesting and/or instructing to shut down and/or modify the manufacturing process of the evaluated manufactured items.

The anomaly spatial information may indicate that two or more different locations exhibit the same anomality likelihood and/or may indicate that two or more different locations exhibit different likelihood.

When the anomaly spatial information indicates that two or more different locations exhibit different likelihood-then step 1130 may treat pixels of the two or more different locations at a different manner—for example may be more sensitive to abnormalities in one location (for example a location that is more error prone)—in relation to abnormalities in another location (for example—a location that is less error prone).

For example—assuming that the anomaly likelihoods includes a first anomaly likelihood and a second anomaly likelihood that exceeds the first anomaly likelihood. Under this assumption—step 1130 may include applying a first anomaly detection rule at a location that exhibits the first anomaly likelihood; and applying a second anomaly detection rule at a location that exhibits the second anomaly likelihood. The first anomaly detection rule may be less sensitive to anomalies than the second anomaly detection rule. For example—the first anomaly detection rule that includes detecting an anomaly when a probability of an occurrence of the anomaly exceeds a first threshold—whereas the second anomaly detection rule includes detecting the anomaly when the probability of the occurrence of the anomaly exceeds a second threshold that is lower than the first threshold.

The anomaly spatial information may be represented in many manners. For example—it may be a sensitivity matrix. In this case the applying of the location-based anomality detection process may include calculating probabilities of occurrences of anomalies at different locations of the evaluated manufactured items.

Step 1110 may include receiving or calculating a sensitivity threshold matrix. The sensitivity threshold matrix may be based on the sensitivity matrix and on one or more probabilities of an occurrence of the anomaly at one or more locations of the evaluated manufactured items.

When obtaining the sensitivity threshold matrix-using the Step 1130 may include comparing the probabilities of occurrences of anomalies at different locations of the evaluated MI to the elements of the sensitivity threshold matrix.

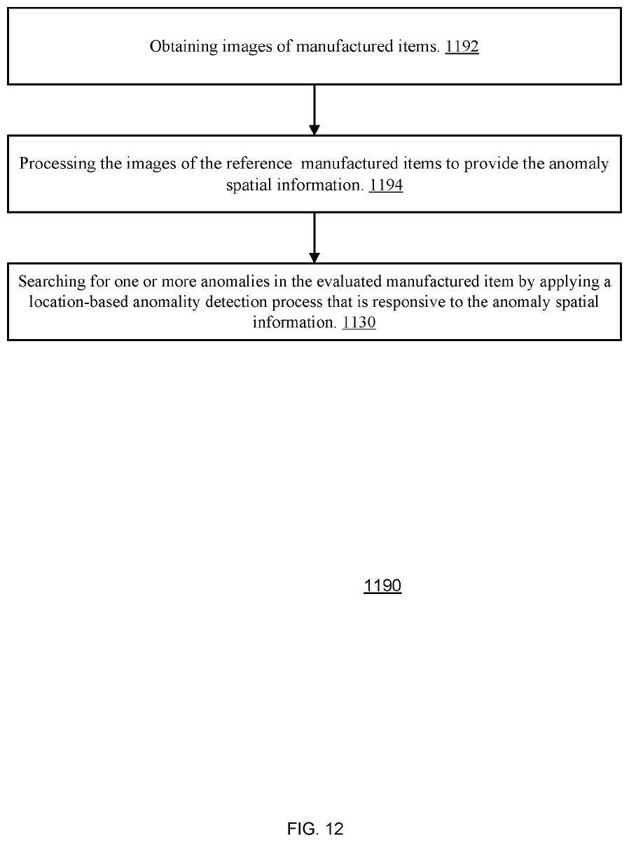

FIG. 12 illustrates method 1190 for generating the anomaly spatial information regarding anomaly likelihoods at different locations of reference manufactured items.

Method 1190 may include step 1192 obtaining images of manufactured items (for example manufactured items)—for example images of faulty manufactured items, or images of manufactured items of unknown status (faulty of OK), or image of faulty and OK manufactured items, tagged images of manufactured items, untagged images of manufactured items, a combination of tagged and untagged images of manufactured items.

Step 1192 may be followed by step 1194 of processing the images of the reference manufactured items to provide the anomaly spatial information. The processing may be executed using a machine learning process, without using a machine learning process, by a combination of a machine learning process and non-machine learning process processing, in a supervised manner, in a non-supervised manner, by a combination of a supervised manner and non-supervised manner.

Step 1194 may include mapping anomalies to locations and then using the mapping to calculate the probabilities of occurrences of anomalies at different locations. A location with a higher abnormality count has a higher probability of occurrence of an abnormality in comparison to a location within a lower abnormality count.

It should be noted that the count may be of abnormalities of any type per location.

It should be noted that there may be different classes of abnormalities and the anomaly spatial information may be indicative of a probabilities of occurrence per class of abnormality—of per group of classes of abnormality.

A probability of a certain location may be calculated, for example, by dividing a number of abnormalities found that the certain location by a normalizing factor—for example the number of images or the highest number of abnormalities found in any of the locations. Any other functions may be used.

The following example provides an example of the generating of the anomaly spatial information and of using the anomaly spatial information during an evaluation process. The generating of the anomaly spatial information may include:
Find images of faulty reference manufactured items—for example finding these images out of a large untagged dataset.
Generating an initial abnormality matrix with the distribution of the locations of the abnormalities.
Normalizing the initial abnormality matrix to provide a normalized initial abnormality matrix. For example—divide each element of the initial abnormality matrix by the highest value of the initial abnormality matrix.
Calculating a sensitivity matrix by subtracting the initial abnormality matrix from one.

The evaluation process may include:
Obtaining an image of an evaluated manufactured item.
Apply standard scalar (relatively low value) as threshold for entire prediction map. Assuming certain values pass the initial standard threshold continue to the next step—otherwise the evaluated manufactured item is assumed to be OK.
Gather the Max (Median, Mean, n^{th} Percentile—mutatis mutandis) Score (Prediction Certainty) in the input image and assign it as X.
Calculate Sensitivity Threshold Matrix defined by:

$$Sensitivity Thresh Matrix = X * Sensitivity Matrix$$

Apply Sensitivity Threshold Matrix as an adaptive threshold map over the predicted feature map.

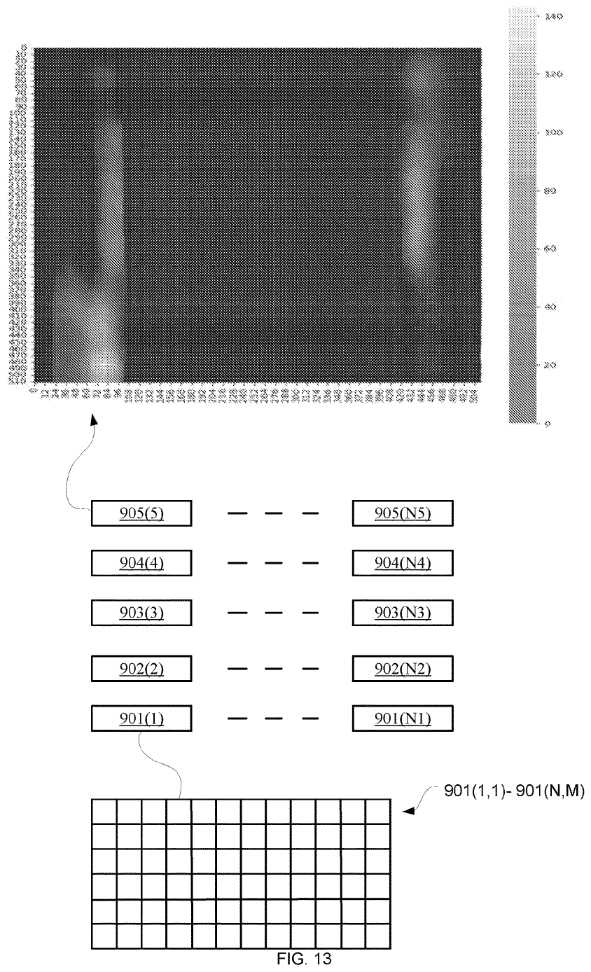

FIG. 13 illustrates examples of various images and/or data structures such as images 901(1)-901(N1) of reference manufactured items, images 902(1)-902(N2) of evaluated manufactured items, anomaly spatial information 902, one or more sensitivity matrixes 909(1)-909(N9), one or more normalized sensitivity matrixes 904(1)-904(N4) and one or more sensitivity threshold matrixes 905(1)-905(N5), whereas N1, N2, N9, N4, N5 are integers that exceed zero. For example—there may be a single sensitivity matrix, many evaluated manufactured items, and the like. FIG. 9 also illustrates an image 901(1) of a reference manufacture item that is virtually segmented to N×M segments (901(1,1)-901(N,M)), whereas N and M are integers that exceed one- and in this case the various matrices mentioned above have N×M or M×N elements.

The suggested method provides an adaptive evaluation process that increases the accuracy of detection and provided a resource saving (usage of matrices or spatial information represented in a compact manner) solution to the evaluation process.

### Generic-Clustering Concept

There may be provided a method that may obtain selected features out of a larger group of features. The selection may be made used untagged first test images. The selection may maintain a small fraction of the larger group of features. The selection may include clustering, k-means, and the like.

Cross correlations may be calculated between a model that includes the selected feature and features generated by a neural network when fed with second test images. Per selected feature a minimum cross correlation and a maximum cross correlation is found (out pf the feature generated for the second test images). When a maximum cross correlation between a selected feature and a feature of a certain image is found—the value of the maximum cross correlation can be replaced by the value of the selected feature (when the latter exceeds the value of the selected feature). The same applies, mutatis mutandis (for example taking the lower value) in relation to the minimum cross correlation.

The minimum and maximum cross correlations are used to determine a probabilistic function (rather determine the coefficients of the probabilistic function).

The probabilistic function is associated with a classifier that calculates the value of the probabilistic function and compares the value to one or more threshold—to determine whether an evaluated IM has a defect of a certain class.

Using classifiers is simpler and requires less memory and computational resources.

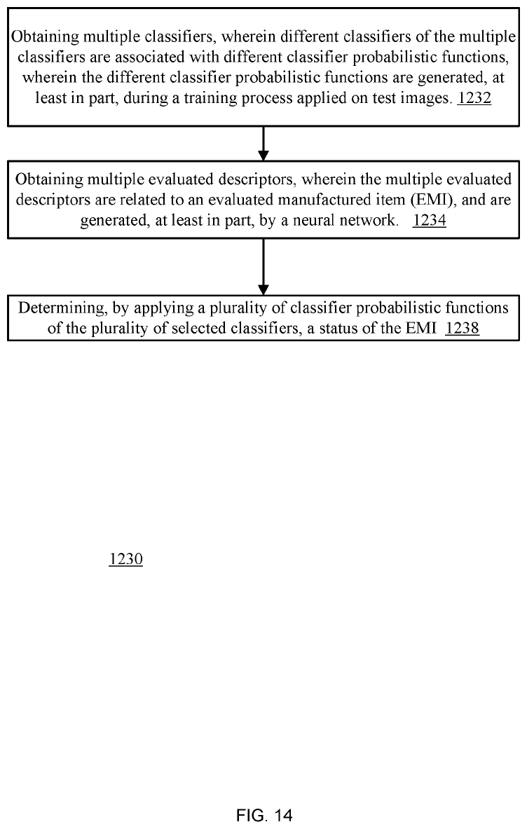

FIG. 14 illustrates an example of method 1230 for defect detection.

Method 1230 may start by step 1232 of obtaining multiple classifiers, wherein different classifiers of the multiple classifiers are associated with different classifier probabilistic functions, wherein the different classifier probabilistic functions are generated, at least in part, during a training process applied on test images.

Step 1232 may be followed by step 1234 of obtaining multiple evaluated descriptors, wherein the multiple evaluated descriptors are related to an evaluated manufactured item (EMI), and are generated, at least in part, by a neural network.

Step 1234 may be followed by step 1238 of determining, by applying a plurality of classifier probabilistic functions of the plurality of selected classifiers, a status of the EMI.

At least one evaluated descriptor is associated with a single selected classifier.

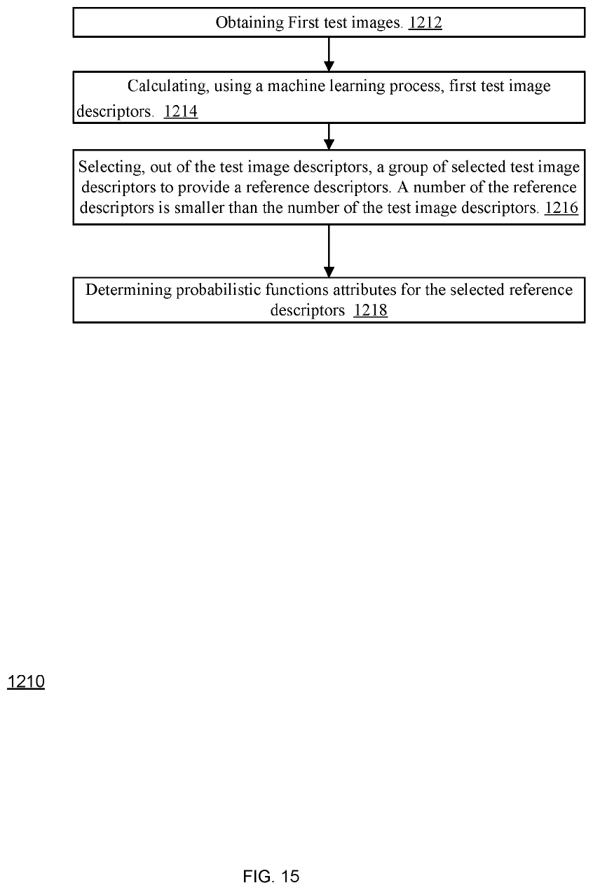

FIG. 15 illustrates method 1210 for determining probabilistic functions.

Method 1210 may start by step 1212 of obtaining test images.

Step 1212 may be followed by step 1214 of calculating, using a machine learning process, first test image descriptors.

Step 1214 may be followed by step 1216 of selecting, out of the test image descriptors, a group of selected test image descriptors to provide a reference descriptors. A number of the reference descriptors is smaller than the number of the test image descriptors.

Step 1216 may be followed by step 1218 of determining probabilistic functions attributes for the selected reference descriptors.

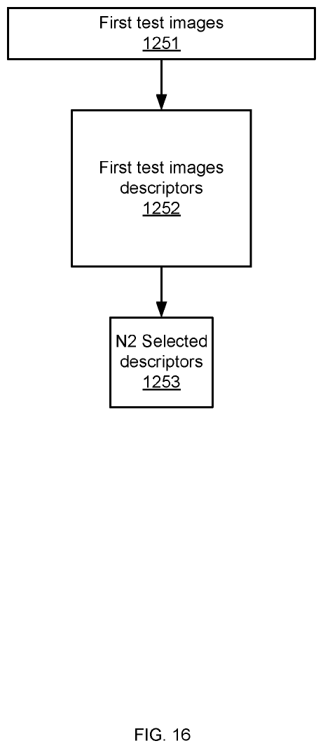

FIG. 16 illustrates an example of selecting selected descriptors.

First test images (1251) are obtained.

First test images descriptors are calculated 1252.

N2 selected descriptors are calculated.

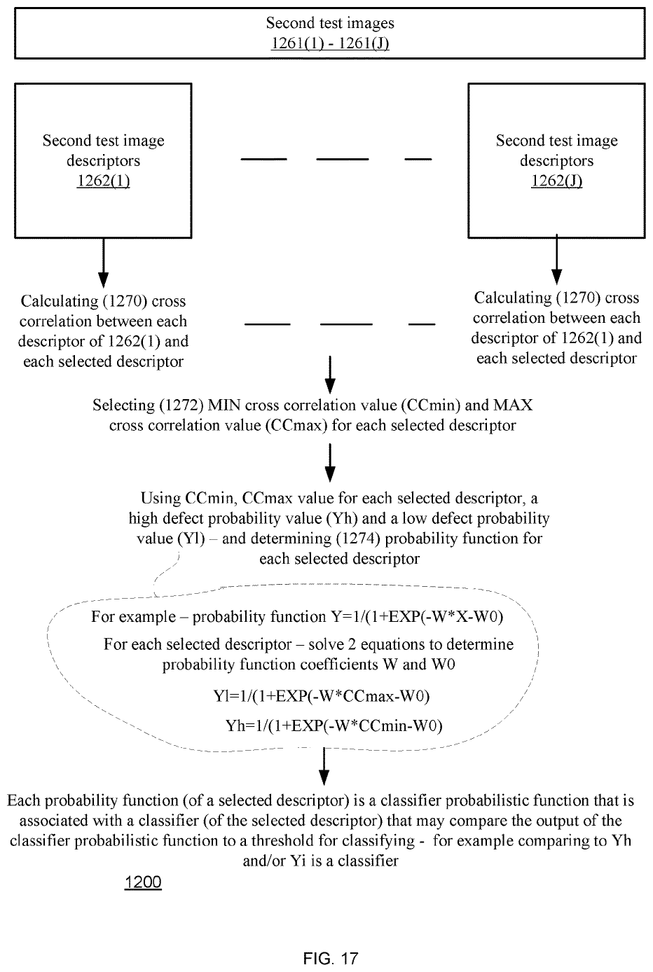

FIG. 17 is an example of method 1260 for determining probabilistic functions attributes for the selected reference descriptors.

The method starts by obtaining second test images (1261(1)-1261(J)) are obtained.

The method continues by calculating, for each of the J second test images second test image descriptors are calculated-1262(1)-1262(J).

The descriptors may be outputted from a layer or from more than a layer of a neural network.

The method continues by step 1270 of calculating cross correlations between the selected descriptors (reference model) and the descriptors of the second test image descriptors. Thus—for each selected descriptor there are J cross correlation values.

Step 1270 may be followed by step 1272 of selecting (out of the J cross correlations per selected descriptor) a MIN cross correlation value (CCmin) and a MAX cross correlation value (CCmax) for each selected descriptor

Step 1272 may be followed by step 1274 of using CCmin, CCmax value for each selected descriptor, a high defect probability value (Yh) and a low defect probability value (Yl), determining probability function for each selected descriptor.

For example:
a. Assuming a probability function Y=1/(1+EXP(−W*X−W0)
b. For each selected descriptor—solve 2 equations to determine probability function coefficients W and W0.

$$Yl = 1 / ( 1 + EXP ( - W * CC max - W 0 ) . \qquad c$$

$$Yh = 1 / ( 1 + EXP ( - W * CC min - W0 ) . \qquad d$$

Each probability function (of a selected descriptor) is a classifier probabilistic function that is associated with a classifier (of the selected descriptor) that may compare the output of the classifier probabilistic function to a threshold for classifying—for example comparing to Yh and/or Yi is a classifier.

Method 1260 may be executed without performing box subnet calculations.

### Online Learning to Accommodate for Process Variation

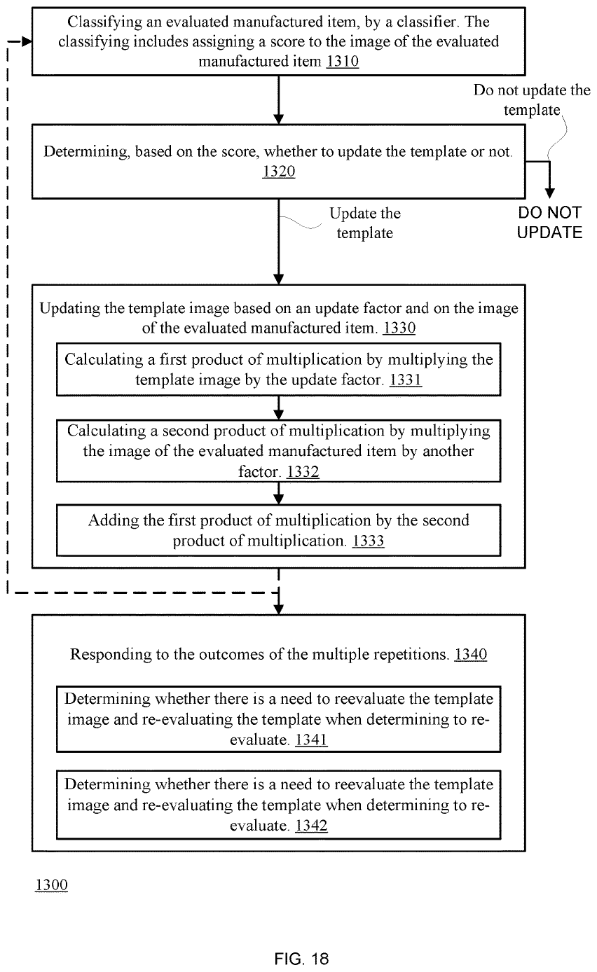

FIG. 18 illustrates an example of method 1300 for generating a process variation sensitive reference template.

Method 1300 may start by step 1310 of classifying an evaluated manufactured item, by a classifier.

The classifying includes assigning a score to an image of the evaluated manufactured item.

The classifying is based on the image of the evaluated manufactured item and on a template image that represents an acceptable manufactured item.

Step 1310 may include obtaining the image of the evaluated manufactured item and obtaining a template image. An obtaining may include receiving or generating, illuminating the evaluated manufactured item, retrieving the image of the manufacture item, generating an initial template image based on design information and/or a defect free manufactured item—or any other manner.

For example—the score may represent any aspect of a difference between the template image and the image of the evaluated manufactured item. The score may be a comparison result such a difference between the template image and the image of the evaluated manufactured item, a probability that the evaluated manufactured item is defected, a similarity score, and the like.

Step 1310 may include using a mapping (or one or rules) that maps the value of the score to the status of the evaluated manufactured item. For example—a dual-class classifier may associate a first range of score values to an acceptable (for example—OK) evaluated manufactured item and a second range of score values to a unacceptable (for example—not good (NG))) evaluated manufactured item. There may be more than two classes.

An acceptable manufactured item may be defect free. An acceptable manufactured item may be an manufactured item that may not be completely defect free—but may be acceptable according to a certain definition. The certain definition may be determined in any manner—for example may be determined by a manufacturer of the manufactured item, by a consumer of the manufactured item, by a client of the manufacturer, based on previous tests of the manufactured item, and the like.

An acceptable manufactured item may exhibit at least one of the following—be of an acceptable functionality and/or include an acceptable overall number of defects and/or include an acceptable distribution of defects, include an acceptable type of defects, and the like.

The first range and/or the second range of the score may be determined in any manner and by any entity—for example—the manufacturer, the client of the manufacturer, an operator of the manufacturing process tool 520, a technical specification, and the like.

Step 1310 may be followed by step 1320 of determining, based on the score, whether to update the template or not. The determining may reflect whether the score is indicative of an acceptable evaluated manufactured item or an unacceptable evaluated manufactured item.

When determining that the score is indicative of an unacceptable evaluated manufactured item (for example—when the score of the image of the evaluated manufactured item is within the second range) then step 1320 is followed by step 1340 of not updating the template image.

When determining that the score is indicative of an acceptable evaluated manufactured item (for example—when the score is within the first range) then step 1320 is followed by step 1330 of updating the template image based on an update factor and on the image of the evaluated manufactured item.

When determining to update the template (for example—when the score of the image of the evaluated manufactured item is within the first range).

Step 1330 may include step 1331 of calculating a first product of multiplication by multiplying the template image by the update factor, step 1332 of calculating a second product of multiplication by multiplying the image of the evaluated manufactured item by another factor, and step 1333 of adding the first product of multiplication by the second product of multiplication.

The other factor may equal one minus the update factor. The other factor may be calculated based on the update factor—in any manner.

Steps 1310, 1320 and 1330 may be repeated multiple times-whereas different repetitions or iterations are related to different evaluated manufactured items.

The multiple repetitions of steps 1310, 1320 and 1330 may be followed by step 1340 of responding to the outcomes of the multiple repetitions.

Step 1340 may include step 1342 of determining whether there is a need to reevaluate the template image and re-evaluating the template when determining to reevaluate.

The evaluated manufactured items are manufactured by a manufacturing process that may exhibit a certain defected manufactures items statistics—for example having about X % of faulty manufactures items. X may have any value—for example may range between 0.1 and 10, between 1 and 20, between 15 and 30, and the like).

If the multiple repetitions exhibit a substantially higher percent of faulty manufactured items (for example—1.1X %, between 1.2X % to 1.5% and even more)—step 1340 may reach a conclusion that this increase in the percent of faulty manufactured items should be contributed to process variations—that may deem the template less relevant.

Step 1340 may include step 1344 of determining to generate a process variation alert and generating the process variation alert.

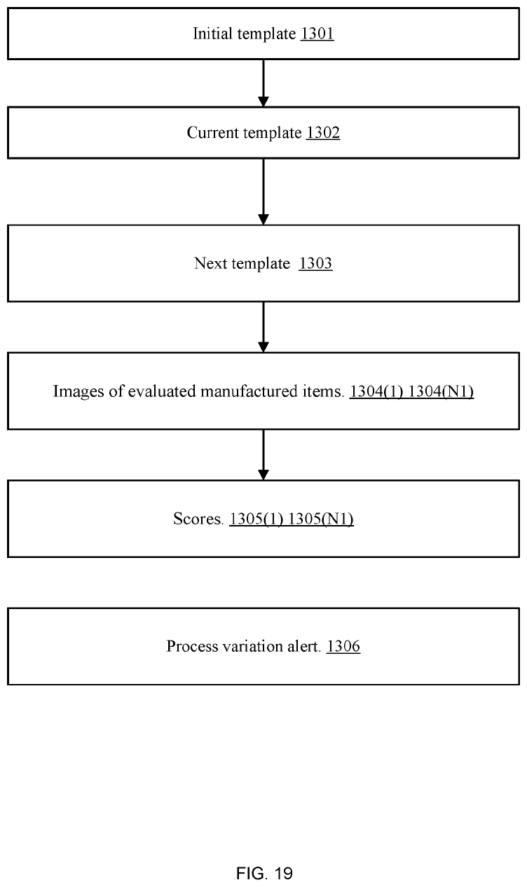

FIG. 19 illustrates examples of data structures.

Assuming that there are N1 iterations of steps 1310-1330. Under these assumptions—the data structures may include initial template image 1301, current template 1302 (a template at a beginning of step 1310 of an iteration of steps 1310-1330), next template 1303 (a template following an execution of an iteration of steps 1330), images of evaluated manufactured items 1304(1)-1304(N1), scores 1305(1)-1305(N1) and process variation alert 1306. A next template of one iteration is the current template of the next iteration.

Step 1340 may be executed one or more than two times during the N1 iterations.

### Reducing the Dimensionality of Descriptors

There may be provided a method for compressing descriptors of any layer of a neural network—while maintaining descriptor segments related to the important channels.

The method may operate in real time and may process hundreds, thousands, tens of thousands and even more descriptors per second. The fast processing allows to reduce irrelevant information very quickly and can save resources in a highly effective manner.

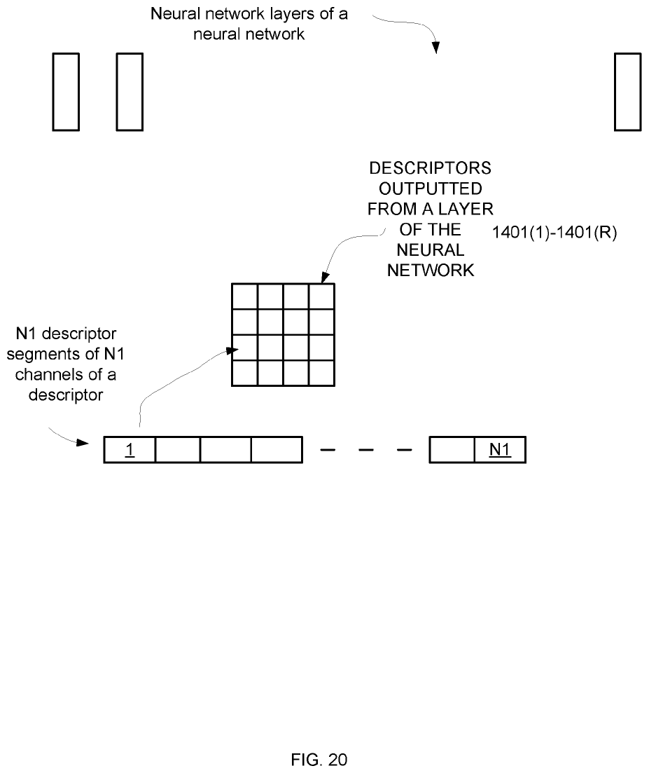

FIG. 20 illustrates an example of descriptors 1410(1)-1410(R), that include a first number (N1) of descriptor segments—related to N1 channels.

The descriptors may for a descriptor map, may outputted from any layer of a neural network or from only some of the layers of the neural network. Different layers may output a different number of descriptors having a different number of channels each.

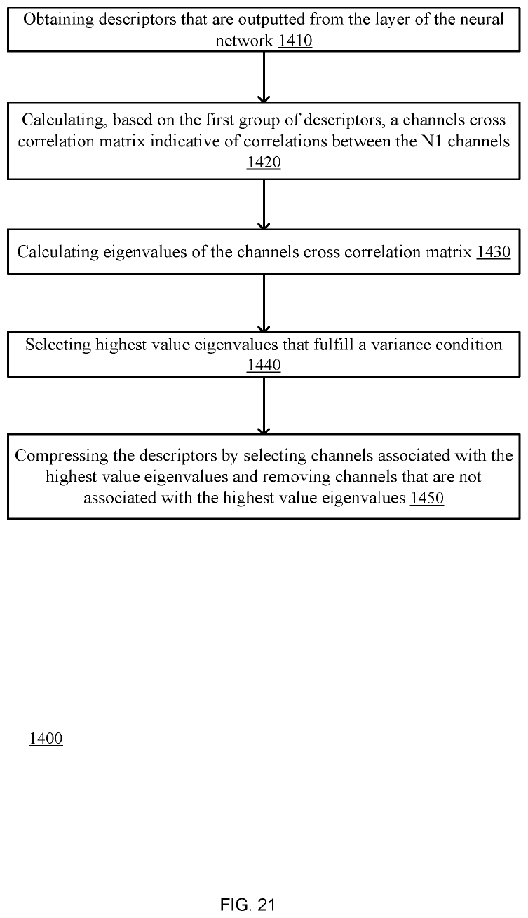

FIG. 21 illustrates method 1400 for channel reduction of multi-channel descriptors of a layer of a neural network.

Method 1400 may start by step 1410 of obtaining descriptors that are outputted from the layer of the neural network. Each descriptor has a first number (N1) of descriptor segments from N1 channels. The value of N1 may differ from one layer to another.

Step 1410 may be followed by step 1420 of calculating, based on the first group of descriptors, a channels cross correlation matrix indicative of correlations between the N1 channels.

Step 1420 may include converting each descriptor to a vector and calculating cross correlations between the vectors.

Step 1420 may be followed by step 1430 of calculating eigenvalues of the channels cross correlation matrix.

Step 1430 may be followed by step 1440 of selecting highest value eigenvalues that fulfill a variance condition.

The variance condition may be fulfilled when a requested variance value does not exceed a ratio between (a) a sum of the highest value eigenvalues, and (b) a sum of all eigenvalues of the channels cross correlation matrix.

Step 1440 may be an iterative process that may include adding a new eigenvalue to a current set of eigenvalues that have a higher value that the new eigen value and checking if the sum of the current set and the new eigenvalue fulfills the condition. The first iteration may check the ratio between the eigenvalue of the highest value to the a sum of all eigenvalues of the channels cross correlation matrix.

For example—during a first iteration—calculating the ratio between (i) the highest value eigenvalue and (ii) the sum of all eigenvalues of the channels cross correlation matrix. During a second iteration—calculating the ratio between (i) a sum of the highest value eigenvalue and the second highest value eigenvalue, and (ii) the sum of all eigenvalues of the channels cross correlation matrix. During a k'th iteration calculating the ratio between (i) a sum of the k'th highest value eigenvalues, and (ii) the sum of all eigenvalues of the channels cross correlation matrix.

Step 1440 may be followed by step 1450 of compressing the descriptors by selecting channels associated with the highest value eigenvalues and removing channels that are not associated with the highest value eigenvalues.

The channels cross correlation matrix may be a normalized channels cross correlation matrix—in which each element of the channels cross correlation matrix is normalized by an average per channel value.

The method may include:
a. Inputting a percentage of variance to save (var-percent).
b. For each descriptor—computing Ci and Mean Value Mi
c. For each descriptor—computing (Ci−Mi) to provide a current Ci
d. Decomposing each current Ci into eigenvalues and eigenvectors.
e. For each descriptor—select the K'th largest eigenvalue locations that fulfill

$$\frac{\{ {\sum }_{i = 1 , {k}^{λ}} \}}{\sum λ} \geq var - precent .$$

The method may include:
a. Obtaining multiple (N×W) descriptors—each having C channels.
b. Flattening the descriptors to vectors of N×W×C.
c. Averaging per each channel Ci across all data to provide Xm (C×1).
d. Computing an average (X−Xm)(X−Xm)^{T}/(N−1) to provide the cross correlation matrix C
e. Computing eigenvalues (or eigenvectors) of C and sort them in decreasing order.
f. Selecting the sum (k highest eigenvalues) where

$${\sum }_{i = 1}^{k} λ i / {\sum }_{i = 1}^{C} λ i >= T ,$$

that is, select channels that provide T percent of variance. T may be selected in any manner and by any person or entity.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for region of interest (ROI) defect detection related to an evaluated manufactured item (MI), the method comprising:
obtaining a reference MI image;
obtaining a reference ROI definition;
obtaining the evaluated MI image;
feeding the reference MI image and the evaluated MI image to a neural network;
detecting, by the neural network, one or more geometrical warping operations that once applied on the reference MI image results in an approximation of the evaluated MI image;
applying the one or more geometrical warping operations on the reference ROI definition to provide a definition of an evaluated MI image ROI; and
applying an ROI-based defect detection process on the evaluated MI image, based on the evaluated MI image ROI.

2. The method according to claim 1, wherein the one or more geometrical warping operations comprise rotation, shift, shearing and projection.

3. The method according to claim 1, wherein the one or more geometrical warping operations are represented by a multi-dimensional warping matrix.

4. The method according to claim 1, wherein the one or more geometrical warping operations are represented by a three by three warping matrix.

5. The method according to claim 1, wherein the neural network is trained by feeding the neural network with test images and randomly wrapped versions of the test images.

6. The method according to claim 1, comprising training the neural network by feeding the neural network with test images and randomly wrapped versions of the test images.

7. The method according to claim 1, comprising training the neural network by feeding the neural network with test images and randomly wrapped versions of the test images, wherein at some test images comprise tagged defects, and wherein the training comprises obtaining information about an appearance of defects in the randomly wrapped versions of the test images.

8. A non-transitory computer readable medium for region of interest (ROI) defect detection related to an evaluated manufactured item (MI), wherein the non-transitory computer readable medium stores instructions that cause a processor tor:
obtain a reference MI image;
obtain a reference ROI definition;
obtain the evaluated MI image;
implement a neural network that is configured to (i) receive the reference MI image and the evaluated MI image to a neural network, and (ii) detect one or more geometrical warping operations that once applied on the reference MI image results in an approximation of the evaluated MI image;
apply the one or more geometrical warping operations on the reference ROI definition to provide a definition of an evaluated MI image ROI; and
apply an ROI-based defect detection process on the evaluated MI image, based on the evaluated MI image ROI.

9. The non-transitory computer readable medium according to claim 9, wherein the one or more geometrical warping operations comprise rotation, shift, shearing and projection.

10. The non-transitory computer readable medium according to claim 9, wherein the one or more geometrical warping operations are represented by a multi-dimensional warping matrix.

11. The non-transitory computer readable medium according to claim 9, wherein the one or more geometrical warping operations are represented by a three by three warping matrix.

12. The non-transitory computer readable medium according to claim 9, wherein the neural network is trained by feeding the neural network with test images and randomly wrapped versions of the test images.

13. The non-transitory computer readable medium according to claim 9, that stores instructions for training the neural network by feeding the neural network with test images and randomly wrapped versions of the test images.

14. The non-transitory computer readable medium according to claim 9, that stores instructions for training the neural network by feeding the neural network with test images and randomly wrapped versions of the test images, wherein at some test images comprise tagged defects, and wherein the training comprises obtaining information about an appearance of defects in the randomly wrapped versions of the test images.

15. A method for region of interest (ROI) defect detection, the method comprising: obtaining one or more ROI masks that are related to one or more areas that comprise one or more ROI of an evaluated manufactured item (EMI); processing an EMI image by a feature pyramid network (FPN) to provide one or more FPN results; wherein the FPN was trained using one or more ROI-masked loss functions; and applying the one or more ROI masks on the one or more FPN results to provide one or more ROI-filtered results that emphasize EMI image pixels located within the one or more areas.

16. The method according to claim 15 wherein the one or more ROI masks are multiple ROI masks.

17. The method according to claim 16 wherein the different ROI masks of the multiple ROI masks are associated with different feature maps, the different feature maps are associated with different spatial resolutions.

18. The method according to claim 17 wherein different ROI masks are associated with different areas of the different feature maps.

19. The method according to claim 18 wherein each area of the different areas comprises an ROI and one or margins.

20. The method according to claim 19 wherein the one or margins are set to compensate for registration errors.

21. The method according to claim 15 comprising training the FPN.

22. The method according to claim 21 wherein the training comprises processing test images by the FPN to provide training FPM results, and applying one or more ROI-masked loss functions on the training FPM results.

23. The method according to claim 21 wherein each one of the one or more ROI-masked loss functions ignores training FPM result metadata related to pixels outside the area.

24. The method according to claim 21 wherein each one of the one or more ROI-masked loss functions comprises a ROI-masked classification loss function and a ROI-masked position loss function.

25. The method according to claim 21 wherein the one or more ROI-masked classification loss functions are one or more ROI-masked focus functions.

26. A non-transitory computer readable medium for region of interest (ROI) defect detection, wherein the non-transitory computer readable medium stores instructions that cause a processor tor: obtain one or more ROI masks that are related to one or more areas that comprise one or more ROI of an evaluated manufactured item (EMI); process an EMI image by a feature pyramid network (FPN) to provide one or more FPN results; wherein the FPN was trained using one or more ROI-masked loss functions; and apply the one or more ROI masks on the one or more FPN results to provide one or more ROI-filtered results that emphasize EMI image pixels located within the one or more areas.

27. The non-transitory computer readable medium according to claim 26 wherein the one or more ROI masks are multiple ROI masks.

28. The non-transitory computer readable medium according to claim 27 wherein the different ROI masks of the multiple ROI masks are associated with different feature maps, the different feature maps are associated with different spatial resolutions.

29. The non-transitory computer readable medium according to claim 28 wherein different ROI masks are associated with different areas of the different feature maps.

30. The non-transitory computer readable medium according to claim 29 wherein each area of the different areas comprises an ROI and one or margins.

31. The non-transitory computer readable medium according to claim 30 wherein the one or margins are set to compensate for registration errors.

32. The non-transitory computer readable medium according to claim 26 that stores instructions for training the FPN.

33. The non-transitory computer readable medium according to claim 32 wherein the training comprises processing test images by the FPN to provide training FPM results, and applying one or more ROI-masked loss functions on the training FPM results.

34. The non-transitory computer readable medium according to claim 32 wherein each one of the one or more ROI-masked loss functions ignores training FPM result metadata related to pixels outside the area.

35. The non-transitory computer readable medium according to claim 32 wherein each one of the one or more ROI-masked loss functions comprises a ROI-masked classification loss function and a ROI-masked position loss function.

36. The non-transitory computer readable medium according to claim 32 wherein the one or more ROI-masked classification loss functions are one or more ROI-masked focus functions.

37. A computerized method for defect detection, the method comprises:
(a) obtaining an evaluated manufactured item (EMI) image;
(b) generating multiple probability maps by multiple class subnets,
different probability maps of the multiple probability maps are associated with different spatial resolutions;
(c) calculating a merged probability map;
(d) binarizing the merged probability map to provide a binarized probability map;
(e) calculating bounding boxes based on the binarized probability map; and
(f) associating defect probabilities with the bounding boxes, wherein the defect probabilities are calculated based on the merged probability map.

38. The computerized method according to claim 37 wherein the calculating of the bounding boxes comprises detecting edges of the binarized probability map, chaining the edges to provide edge chains and determining the bounding boxes based on the edge chains.

39. The computerized method according to claim 37 wherein the generating of the merged probability map further comprises merging the probability maps.

40. The computerized method according to claim 37 comprising performing steps (a)-(f) without performing box subnet calculations.

41. The computerized method according to claim 37 wherein an associating of a defect probability with a bounding box comprises averaging merged probability map pixels bounded by the bounding box.

42. The computerized method according to claim 37 wherein an associating of a defect probability with a bounding box comprises finding a highest value probability map pixel output probability map pixels bounded by the bounding box.

43. A non-transitory computer readable medium for defect detection, wherein the non-transitory computer readable medium stores instructions that cause a processor to:
(a) obtain an evaluated manufactured item (EMI) image;
(b) generating multiple probability maps by multiple class subnets, different probability maps of the multiple probability maps are associated with different spatial resolutions;
(c) calculate a merged probability map;
(d) binarize the merged probability map to provide a binarized probability map;
(e) calculate bounding boxes based on the binarized probability map; and
(f) associate defect probabilities with the bounding boxes, wherein the defect probabilities are calculated based on the merged probability map.

44. The non-transitory computer readable medium according to 43 wherein the calculating of the bounding boxes comprises detecting edges of the binarized probability map, chaining the edges to provide edge chains and determining the bounding boxes based on the edge chains.

45. The non-transitory computer readable medium according to 43 wherein the generating of the merged probability map further comprises merging the probability maps.

46. The non-transitory computer readable medium according to 43 that stores instructions for performing steps (a)-(f) without performing box subnet calculations.

47. The non-transitory computer readable medium according to 43 wherein an associating of a defect probability with a bounding box comprises averaging merged probability map pixels bounded by the bounding box.

48. The non-transitory computer readable medium according to 43 wherein an associating of a defect probability with a bounding box comprises finding a highest value probability map pixel output probability map pixels bounded by the bounding box.

49. A method for anomaly detection, the method comprises:
obtaining anomaly spatial information regarding anomaly likelihoods at different locations of reference manufactured items;
obtaining an image of an evaluated manufactured item; and
searching for one or more anomalies in the evaluated manufactured item by applying a location-based anomality detection process that is responsive to the anomaly spatial information.

50. The method according to claim 49, wherein the anomaly likelihoods comprise a first anomaly likelihood and a second anomaly likelihood; wherein the second anomaly likelihood exceeds the first anomaly likelihood;
wherein the applying of the location-based anomaly detection process comprises:
applying a first anomaly detection rule at a location that exhibits the first anomaly likelihood; and
applying a second anomaly detection rule at a location that exhibits the second anomaly likelihood; wherein the first anomaly detection rule is less sensitive to anomalies than the second anomaly detection rule.

51. The method according to claim 50, wherein the first anomaly detection rule comprises detecting an anomaly when a probability of an occurrence of the anomaly exceeds a first threshold; wherein the second anomaly detection rule comprises detecting the anomaly when the probability of the occurrence of the anomaly exceeds a second threshold; and wherein the first threshold exceeds the second threshold.

52. The method according to claim 49, wherein the anomaly spatial information is a sensitivity matrix.

53. The method according to claim 52, wherein the applying of the location-based anomality detection process comprises calculating probabilities of occurrences of anomalies at different locations of the evaluated manufactured item.

54. The method according to claim 53, comprising calculating a sensitivity threshold matrix, based on the sensitivity matrix and on one or more probabilities of an occurrence of the anomaly at one or more locations of the evaluated manufactured item.

55. The method according to claim 54, comprising comparing the probabilities of occurrences of anomalies at different locations of the evaluated manufactured item to the elements of the sensitivity threshold matrix.

56. The method according to claim 49, wherein the obtaining of the anomaly spatial information comprises generating the anomaly spatial information.

57. The method according to claim 56, wherein the generating of the anomaly spatial information comprises calculating probabilities of occurrences of anomalies at different locations of reference manufactured items.

58. The method according to claim 56, wherein the generating of the anomaly spatial information comprises training a machine learning process.

59. The method according to claim 49, wherein the reference manufactured items are instances of a reference manufactured item that is similar to the evaluated manufactured item.

60. A non-transitory computer readable medium for animality detection, wherein the non-transitory computer readable medium stores instructions for:
obtaining anomaly spatial information regarding anomaly likelihoods at different locations of reference manufactured items;
obtaining an image of an evaluated manufactured item; and
searching for one or more anomalies in the evaluated manufactured item by applying a location-based anomality detection process that is responsive to the anomaly spatial information.

61. The non-transitory computer readable medium according to claim 60 wherein the anomaly likelihoods comprise a first anomaly likelihood and a second anomaly likelihood; wherein the second anomaly likelihood exceeds the first anomaly likelihood;
wherein the applying of the location-based anomaly detection process comprises:
applying a first anomaly detection rule at a location that exhibits the first anomaly likelihood; and applying a second anomaly detection rule at a location that exhibits the second anomaly likelihood; wherein the first anomaly detection rule is less sensitive to anomalies than the second anomaly detection rule.

62. The non-transitory computer readable medium according to claim 61 wherein the first anomaly detection rule comprises detecting an anomaly when a probability of an occurrence of the anomaly exceeds a first threshold;
wherein the second anomaly detection rule comprises detecting the anomaly when the probability of the occurrence of the anomaly exceeds a second threshold; and
wherein the first threshold exceeds the second threshold.

63. The non-transitory computer readable medium according to claim 60 wherein the anomaly spatial information is a sensitivity matrix.

64. The non-transitory computer readable medium according to claim 63 wherein the applying of the location-based anomality detection process comprises calculating probabilities of occurrences of anomalies at different locations of the evaluated manufactured item.

65. The non-transitory computer readable medium according to claim 64 that stores instructions for calculating a sensitivity threshold matrix, based on the sensitivity matrix and on one or more probabilities of an occurrence of the anomaly at one or more locations of the evaluated manufactured item.

66. The non-transitory computer readable medium according to claim 65 that stores instructions for comparing the probabilities of occurrences of anomalies at different locations of the evaluated manufactured item to the elements of the sensitivity threshold matrix.

67. The non-transitory computer readable medium according to claim 60 wherein the obtaining of the anomaly spatial information comprises generating the anomaly spatial information.

68. The non-transitory computer readable medium according to claim 67 wherein the generating of the anomaly spatial information comprises calculating probabilities of occurrences of anomalies at different locations of reference manufactured items.

69. The non-transitory computer readable medium according to claim 68 wherein the generating of the anomaly spatial information comprises training a machine learning process.

70. A method for defect detection, the method comprises: obtaining multiple classifiers, wherein different classifiers of the multiple classifiers are associated with different classifier probabilistic functions, wherein the different classifier probabilistic functions are generated, at least in part, during a training process applied on test images; obtaining multiple evaluated descriptors, wherein the multiple evaluated descriptors are related to an evaluated manufactured item (EMI), and are generated, at least in part, by a neural network; and determining, by applying a plurality of classifier probabilistic functions of the plurality of selected classifiers, a status of the EMI.

71. The method according to claim 70, wherein at least one evaluated descriptor is associated with a single selected classifier.

72. The method according to claim 70, wherein the training process comprises: obtaining test image descriptors; finding reference descriptors candidates of the test image descriptors; selecting selected reference descriptors of the reference descriptors candidates; determining probabilistic functions attributes for the selected reference descriptors; and calculating the different classifier probabilistic functions associated with the different classifiers, based on the probabilistic function attributes.

73. The method according to claim 72, wherein the probabilistic function attributes comprises a minimal cross correlation and a maximal cross correlation.

74. The method according to claim 73, wherein a calculating of a probabilistic function comprises calculating a function y=1/(1+exponential (x*w−wo)), wherein wo and w are variables, and x equals a minimal cross correlation or a maximal cross correlation.

75. The method according to claim 70, comprising executing the training process, wherein the executing of the training process comprises: obtaining test image descriptors; finding reference descriptors candidates of the test image descriptors; selecting selected reference descriptors of the reference descriptors candidates; determining probabilistic functions attributes for the selected reference descriptors; and calculating the different classifier probabilistic functions associated with the different classifiers, based on the probabilistic function attributes.

76. The method according to claim 75, wherein the probabilistic function attributes comprises a minimal cross correlation and a maximal cross correlation.

77. The method according to claim 76, wherein a calculating of a probabilistic function comprises calculating a function y=1/(1+exponential (x*w-wo)), wherein wo and w are variables, and x equals a minimal cross correlation or a maximal cross correlation.

78. A non-transitory computer readable medium for defect detection wherein the non-transitory computer readable medium stores instructions for: obtaining multiple classifiers, wherein different classifiers of the multiple classifiers are associated with different classifier probabilistic functions, wherein the different classifier probabilistic functions are generated, at least in part, during a training process applied on test images; obtaining multiple evaluated descriptors, wherein the multiple evaluated descriptors are related to an evaluated manufactured item (EMI), and are generated, at least in part, by a neural network; and determining, by applying a plurality of classifier probabilistic functions of the plurality of selected classifiers, a status of the EMI.

79. The non-transitory computer readable medium according to claim 78, wherein at least one evaluated descriptor is associated with a single selected classifier.

80. The non-transitory computer readable medium according to claim 78, wherein the training process comprises: obtaining test image descriptors; finding reference descriptors candidates of the test image descriptors; selecting selected reference descriptors of the reference descriptors candidates; determining probabilistic functions attributes for the selected reference descriptors; and calculating the different classifier probabilistic functions associated with the different classifiers, based on the probabilistic function attributes.

81. The non-transitory computer readable medium according to claim 80, wherein the probabilistic function attributes comprises a minimal cross correlation and a maximal cross correlation.

82. The non-transitory computer readable medium according to claim 81, wherein a calculating of a probabilistic function comprises calculating a function y=1/(1+exponential (x*w−wo)), wherein wo and w are variables, and x equals a minimal cross correlation or a maximal cross correlation.

83. The non-transitory computer readable medium according to claim 82, comprising executing the training process, wherein the executing of the training process comprises: obtaining test image descriptors; finding reference descriptors candidates of the test image descriptors; selecting selected reference descriptors of the reference descriptors candidates; determining probabilistic functions attributes for the selected reference descriptors; and calculating the different classifier probabilistic functions associated with the different classifiers, based on the probabilistic function attributes.

84. The non-transitory computer readable medium according to claim 83, wherein the probabilistic function attributes comprises a minimal cross correlation and a maximal cross correlation.

85. The non-transitory computer readable medium according to claim 84, wherein a calculating of a probabilistic function comprises calculating a function y=1/(1+exponential (x*w−wo)), wherein wo and w are variables, and x equals a minimal cross correlation or a maximal cross correlation.

86. A method for process variation sensitive reference template, the method comprises:
classifying an evaluated manufactured item, by a classifier, wherein the classifying comprises assigning a score to an image of the evaluated manufactured item; wherein the classifying is based on the image of the evaluated manufactured item and on a template image that represents an acceptable manufactured item; and
updating the template image based on an update factor and on the image of the evaluated manufactured item, when the score of the image of the evaluated manufactured item is within a first range.

87. The method according to claim 86, comprising avoiding from updating the template image when the score of the image of the evaluated manufactured item is within a second range that differs from the first range.

88. The method according to claim 86, wherein the updating comprises adding (a) a product of multiplication of the template image by the update factor, and (b) a multiplying the image of the evaluated manufactured item by another factor.

89. The method according to claim 88, wherein the other factor equals one minus the update factor.

90. The method according to claim 86, comprising repeating the classifying and the updating for each evaluated manufactured item out of a group of evaluated manufactured item.

91. The method according to claim 90, comprising determining whether to reevaluate the template image based on outcomes of the repeating of the classifying and updating.

92. The method according to claim 90, comprising determining to reevaluate the template image when determining to reevaluate the template image.

93. The method according to claim 90, comprising determining whether to generate a process variation alert based on outcomes of the repeating of the classifying and updating.

94. The method according to claim 93, comprising generating the process variation alert the template image when determining to generate the process variation alert.

95. A non-transitory computer readable medium for process variation sensitive reference template, wherein the non-transitory computer readable medium stores instructions that cause a processor tor:
classify an evaluated manufactured item, by a classifier, wherein the classifying comprises assigning a score to an image of the evaluated manufactured item; wherein the classifying is based on the image of the evaluated manufactured item and on a template image that represents an acceptable manufactured item; and
update the template image based on an update factor and on the image of the evaluated manufactured item, when the score of the image of the evaluated manufactured item is within a first range.

96. The non-transitory computer readable medium according to claim 95, that stores instructions for avoiding from updating the template image when the score of the image of the evaluated manufactured item is within a second range that differs from the first range.

97. The non-transitory computer readable medium according to claim 95, wherein the updating comprises adding (a) a product of multiplication of the template image by the update factor, and (b) a multiplying the image of the evaluated manufactured item by another factor.

98. The non-transitory computer readable medium according to claim 97, wherein the other factor equals one minus the update factor.

99. The non-transitory computer readable medium according to claim 95, comprising repeating the classifying and the updating for each evaluated manufactured item out of a group of evaluated manufactured item.

100. The non-transitory computer readable medium according to claim 99, comprising determining whether to reevaluate the template image based on outcomes of the repeating of the classifying and updating.

101. The non-transitory computer readable medium according to claim 99, comprising determining to reevaluate the template image when determining to reevaluate the template image.

102. The non-transitory computer readable medium according to claim 99, comprising determining whether to generate a process variation alert based on outcomes of the repeating of the classifying and updating.

103. The non-transitory computer readable medium according to claim 102, comprising generating the process variation alert the template image when determining to generate the process variation alert.

104. A method for channel reduction of multi-channel descriptors of a layer of a neural network, the method comprises:
obtaining descriptors that are outputted from the layer of the neural network; wherein each descriptor comprises a first number (N1) of descriptor segments from N1 channels;
calculating, based on the first group of descriptors, a channels cross correlation matrix indicative of correlations between the N1 channels;
calculating eigenvalues of the channels cross correlation matrix;
selecting highest value eigenvalues that fulfill a variance condition; and
compressing the descriptors by selecting channels associated with the highest value eigenvalues and removing channels that are not associated with the highest value eigenvalues.

105. The method according to claim 104, wherein the variance condition is fulfilled when a requested variance value does not exceed a ratio between (a) a sum of the highest value eigenvalues, and (b) a sum of all eigenvalues of the channels cross correlation matrix.

106. The method according to claim 104, wherein the channels cross correlation matrix is a normalized channels cross correlation matrix that is normalized by an average per channel value.

107. The method according to claim 104, wherein the calculating comprises converting each descriptor to a vector and calculating cross correlations between the vectors.

108. A non-transitory computer readable medium for channel reduction of multi-channel descriptors of a layer of a neural network, wherein the non-transitory computer readable medium stores instructions that cause a processor to:
obtain descriptors that are outputted from the layer of the neural network; wherein each descriptor comprises a first number (N1) of descriptor segments from N1 channels;
calculate, based on the first group of descriptors, a channels cross correlation matrix indicative of correlations between the N1 channels;
calculate eigenvalues of the channels cross correlation matrix;
select highest value eigenvalues that fulfill a variance condition; and
compress the descriptors by selecting channels associated with the highest value eigenvalues and removing channels that are not associated with the highest value eigenvalues.

109. The method according to claim 108, wherein the variance condition is fulfilled when a requested variance value does not exceed a ratio between (a) a sum of the highest value eigenvalues, and (b) a sum of all eigenvalues of the channels cross correlation matrix.

110. The method according to claim 108, wherein the channels cross correlation matrix is a normalized channels cross correlation matrix that is normalized by an average per channel value.

111. The method according to claim 108, wherein the calculating comprises converting each descriptor to a vector and calculating cross correlations between the vectors.

112. A computerized system that comprises a processor that is configured to:
obtain descriptors that are outputted from the layer of the neural network; wherein each descriptor comprises a first number (N1) of descriptor segments from N1 channels;
calculate, based on the first group of descriptors, a channels cross correlation matrix indicative of correlations between the N1 channels;
calculate eigenvalues of the channels cross correlation matrix;
select highest value eigenvalues that fulfill a variance condition; and
compress the descriptors by selecting channels associated with the highest value eigenvalues and removing channels that are not associated with the highest value eigenvalues.

113. The computerized system according to claim 112, wherein the variance condition is fulfilled when a requested variance value does not exceed a ratio between (a) a sum of the highest value eigenvalues, and (b) a sum of all eigenvalues of the channels cross correlation matrix.

114. The computerized system according to claim 112, wherein the channels cross correlation matrix is a normalized channels cross correlation matrix that is normalized by an average per channel value.

115. The computerized system according to claim 112, wherein the calculating comprises converting each descriptor to a vector and calculating cross correlations between the vectors.
